(19) United States
(12) Patent Application Publication
(10) Pub. No.: US 2007/0008739 A1
(43) Pub. Date: Jan. 11, 2007

(54) Light source-guide structure of backlight apparatus with LED light source inserted into light guide plate and backlight apparatus having the same

(75) Inventors: Chang Wook Kim, Anyang (KR); Jae Ky Roh, Suwon (KR); Seong Jae Hong, Yongin (KR); Young Jae Song, Seoul (KR); Byuna Man Kim, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/476,594

(22) Filed: Jun. 29, 2006

(30) Foreign Application Priority Data
Jul. 6, 2005 (KR) 10-2005-0060782

(51) Int. Cl. F21V 7/04

(52) U.S. Cl. 362/612; 362/607; 362/609; 362/624

(57) ABSTRACT

The present invention relates to a light source-guide structure having an LED as a light source and a backlight apparatus having the same. The light source-guide structure includes a light guide plate with grooves formed in a peripheral side thereof and a light source having a transparent package fitted into the groove of the light guide plate with an LED chip inside the transparent package. The structure also includes a wiring substrate for seating the LED chip and reflecting the light from the LED chip to the light guide plate and a reflection layer attached on upper surfaces of the light source and the light guide plate. With the light source inserted into the light guide plate, the loss of light is minimized while the horizontal beam angle of light from the LED is increased, minimizing the peripheral area.

### CLAIM OF PRIORITY

This application claims the benefit of Korean Patent Application No. 2005-60782 filed on Jul. 6, 2005, in the Korean Intellectual Property Office, the disclosure of which is incorporated herein by reference.

### BACKGROUND OF THE INVENTION

1. Field of the Invention

The present invention relates to a backlight apparatus having a Light Emitting Diode (LED) as a light source. More particularly, the present invention relates to a light source-guide structure of a backlight apparatus in which the light source is inserted into a light guide plate to minimize a loss of light incident into the light guide plate from the LED, increasing an amount of the incident light while increasing a horizontal beam angle of the light emitted from the LED, thereby minimizing a peripheral area, and a backlight apparatus having the same.

2. Description of the Related Art

A Liquid Crystal Display (LCD) does not have a light source of its own, thus requires an external illumination, which is a backlight apparatus in general. The backlight apparatus illuminates the LCD from the back and uses a Cold Cathode Fluorescent Lamp (CCFL) and an LED as a light source.

An example of a backlight apparatus according to the prior art is illustrated in FIG. 1.

As shown in FIG. 1, the backlight apparatus 1 includes an LED package 10, a light guide plate 20, a reflection plate 24, a diffusion plate 26 and a pair of prism sheets 28. The backlight apparatus sends the light incident from the LED package 10 into the light guide plate 20 to an LCD panel 30 above, providing illumination to the LCD.

More specifically, the LED package includes an LED chip 12, a lead frame 14 for seating the LED chip 12 and providing electricity, a package body 16 for sealing these constituents and a transparent resin 18 filled in a recess of the package body 16.

The lights L1-L3 generated from the LED chip 12 enter the light guide plate 20 and move about inside the light guide plate 20. When they meet dot patterns 22, they are reflected upward by the reflection plate 24 through the diffusion plate 26 and the prism sheet 28 to reach the LCD panel 30.

At this time, the LED package 10 is disposed in a predetermined interval G from the light guide plate 20. Therefore, when the light enters the light guide plate 20 from the LED package 10, parts of light may leak out of the light guide plate 20, decreasing the amount of light. Also, illumination of the LCD panel 30 does not take place at the back end of the LED package 10 of the backlight apparatus 1, i.e., the region from the opposite side of the transparent resin 18 to the light guide plate 20. Therefore, as the peripheral area surrounding the LCD panel 30 in the entire LCD apparatus, i.e., the Bezel area (peripheral area) is increased, the size of the LCD apparatus is accordingly increased.

In addition, since the LED package 10 has a certain horizontal beam angle, although not shown in the diagram, when a plurality of LED packages 10 are disposed in the side of the light guide plate 20, there exists a certain distance before the point where the lights from the adjacent LED packages meet each other. In other words, illumination of the LCD panel 30 does not take place in the area before the point where the lights from the adjacent LED packages 10 meet each other, which is also a factor for increasing the above described Bezel area.

### SUMMARY OF THE INVENTION

The present invention has been made to solve the foregoing problems of the prior art and it is therefore an object of certain embodiments of the present invention to provide a light source-guide structure of a backlight apparatus in which a light source is inserted into a light guide plate, minimizing a loss of light incident into the light guide plate from an LED, thereby increasing an amount of light incident while increasing a horizontal beam angle of light emitted from the LED to minimize a peripheral area and a backlight apparatus having the same.

It is another object of certain embodiments of the invention to provide a light source-guide structure and a backlight apparatus having the same in which a light source package is formed with transparent resin, and a reflection layer and optionally a reflection plate of a lower part of a light guide plate serves the function of a sidewall of the light source, thereby considerably decreasing a thickness of the structure with no need for a space for the sidewall.

According to an aspect for realizing the object, there is provided a light source-guide structure of a backlight apparatus including: a light guide plate having a groove formed in a peripheral side thereof and extended through the thickness of the light guide plate; a light source including a transparent package fitted into the groove of the light guide plate, a light emitting diode chip disposed inside the transparent package, a wiring substrate for seating the light emitting diode chip and reflecting the light from the light emitting diode chip to the light guide plate; and a reflection layer attached on an upper surface of the light source and an upper surface of a portion of the light guide plate into which the light emitting diode light source is fitted.

In the above light source-guide structure, the package of the light source is bonded to the groove of the light guide plate with an adhesive.

In the above light source-guide structure, the reflection layer, attached on the upper surfaces of the transparent package and of the portion of the light guide plate, is formed in such a width that light incident directly from the light emitting diode chip out of total internal reflection condition does not escape through the upper surface of the transparent package or the light guide plate.

Also in the above light source-guide structure, the reflection layer is formed on a lower surface of the light source as well as a lower surface of the portion of the light guide plate into which the light emitting diode light source is fitted. At this time, it is preferable that the reflection layer formed on the upper surfaces of the light source and the light guide plate has a larger width than the reflection layer formed on the lower surfaces of the light emitting diode light source and the light guide plate.

Further in the above light source-guide structure, the reflection layer is formed on side surfaces of the portion of the light guide plate into which the light emitting diode light source is fitted.

In the above light source-guide structure, the reflection layer is made of metal or reflective coating.

At this time, the reflection layer may comprise metal deposit and it is preferable that the metal deposit comprises at least one selected from a group consisting of Ag, Al, Au, Cu, Pd, Pt, Rd and alloys thereof.

Also, the light source-guide structure may further comprise a transparent insulation layer formed on a lower part of the reflection layer.

At this time, it is preferable that the transparent insulation layer comprises deposit of at least one selected from a group consisting of Al₂O₃, SiN, and SiO₂.

Also, it is preferable that the transparent insulation layer is formed on the entire lower part of the reflection layer or in the vicinity of the wiring substrate.

In the meantime, the reflection layer may comprise reflective coating, and it is preferable that the reflective coating comprises at least one selected from a group consisting of TiO₂, ZnO, CaCo₃ and a mixture thereof.

In addition, the light source-guide structure may further comprise a metal deposit layer formed on an upper surface of the reflection layer and the metal deposit layer may comprise at least one selected from a group consisting of Ag, Al, Au, Cu, Pd, Pt, Rd and alloys thereof.

In addition, the light source-guide structure may further comprise dot patterns formed on a bottom surface of the light guide plate and a reflection plate disposed underneath the dot patterns.

In the light source-guide structure, the transparent package is tightly fitted into the groove of the light guide plate, having the same shape as the groove of the light guide plate.

Moreover, in the light source-guide structure, the reflection plate covers the entire lower surfaces of the light emitting diode package and the light guide plate.

According to another aspect for realizing the above described object, the present invention also provides a backlight apparatus comprising: the above described light source-guide structure; a diffusion plate disposed above the light source-guide structure; and a prism sheet disposed above the diffusion plate.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view of a backlight apparatus according to the prior art;

FIG. 2 is a perspective view of a light source-guide structure according to a first embodiment of the present invention;

FIG. 3 is a perspective view illustrating the light source-guide structure in FIG. 2 with a partially removed reflection layer;

FIG. 4 is an exploded perspective view illustrating the light source-guide structure in FIG. 2;

FIG. 5 is a plan view illustrating the light source-guide structure in FIG. 2;

FIG. 6 is a sectional view taken along the line 6-6 in FIG. 5, illustrating the operation of the light source-guide structure according to the present invention;

FIG. 7 is a sectional view taken along the line 7-7 in FIG. 5;

FIG. 8 is a sectional view corresponding to the sectional view in FIG. 6, illustrating a variation of the light source-guide structure according to the first embodiment;

FIG. 9 is a sectional view corresponding to the sectional view in FIG. 6, illustrating another variation of the light source-guide structure according to the first embodiment;

FIG. 10 is a plan view illustrating the operation of the light source-guide structure according to the present invention;

FIG. 11 is a sectional view corresponding to the sectional view in FIG. 6, illustrating a light source-guide structure according to a second embodiment of the present invention;

FIG. 12 is a sectional view illustrating a first example of the light source-guide structure in FIG. 11;

FIG. 13 is a sectional view illustrating a second example of the light source-guide structure in FIG. 11; and

FIG. 14 is a variation of the light source-guide structure in FIG. 13.

### DETAILED DESCRIPTION OF THE PREFERRED EMBODIMENT

Preferred embodiments of the present invention will now be described in detail with reference to the accompanying drawings.

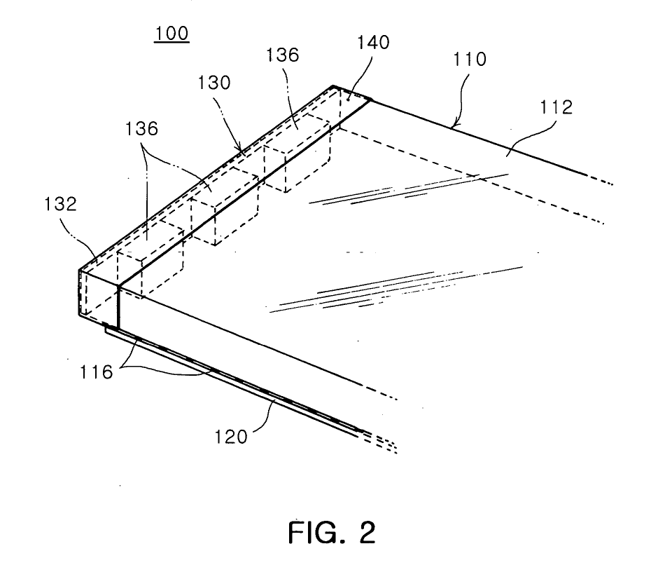

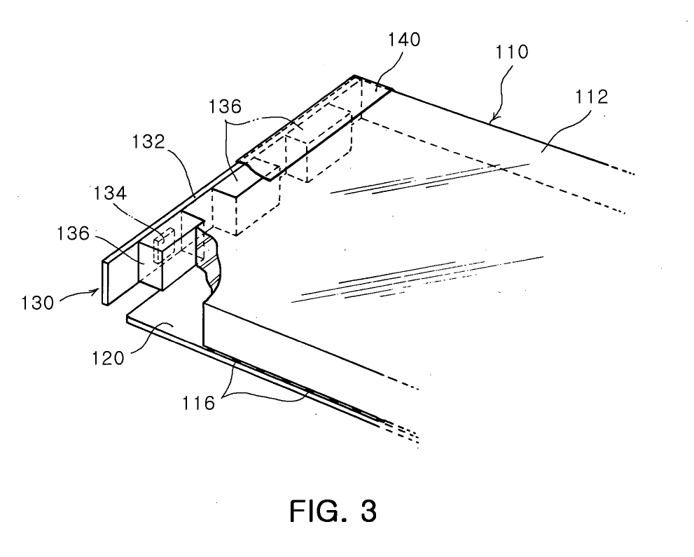

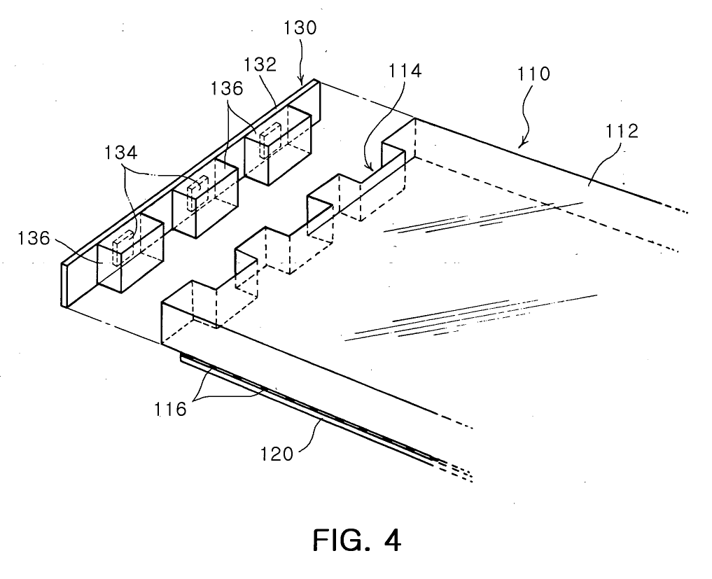

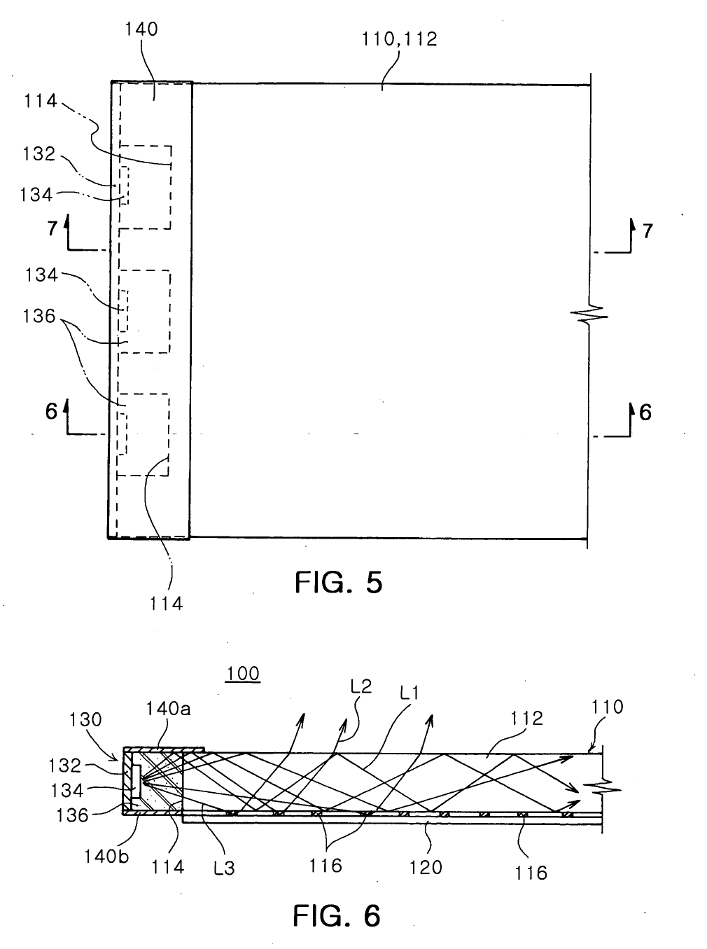

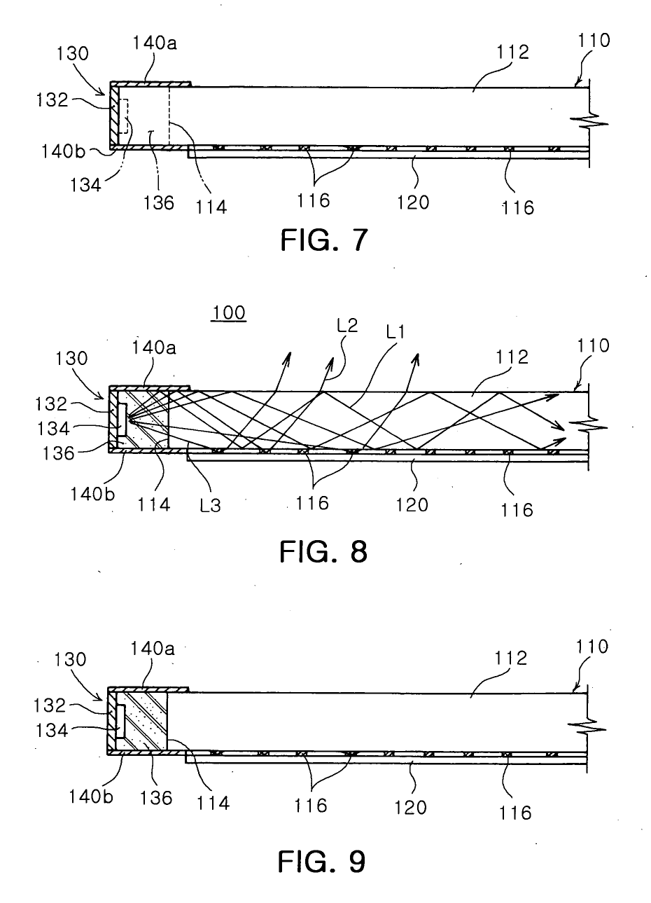

First, with reference to FIGS. 2 to 6, a light source-guide structure according to a first embodiment of the present invention is explained. In these diagrams, FIG. 2 is a perspective view of the light source-guide structure according to the first embodiment of the present invention, FIG. 3 is a perspective view of the light source-guide structure in FIG. 2 with a partially removed reflection layer, and FIG. 4 is a perspective view illustrating a light source and a light guide plate in the light source-guide structure in FIG. 2. FIG. 5 is a plan view of the light source-guide structure in FIG. 2, FIG. 6 is a sectional view taken along the line 6-6 in FIG. 5, and FIG. 7 is a sectional view taken along the line 7-7 in FIG. 5.

As shown in FIGS. 2 to 7, the light source-guide structure 100 according to the first embodiment of the present invention includes a light guide plate 110, a Light Emitting Diode (LED) assembly 130 and a reflection layer 140.

The light guide plate 110 is a planar member having a predetermined thickness and made of transparent acryl, Polymethylmethacrylate (PMMA), plastic or glass. The light guide plate 110 is composed of a planar body 112 and three grooves 114 formed in a peripheral side of the body. These grooves 114 are vertically extended through the side portion of the body 112 in a predetermined dimension.

On the bottom surface of the light guide plate body 112, dot patterns 116 made up of a plurality of ink dots or micro-indentations are formed, with a reflection plate 120 deposited atop the dot patterns 116. The reflection plate 120 typically takes a form of a thin film or a sheet, and preferably is composed of Lambertian surface. In the meantime, unlike what is shown in the diagram, as the dot patterns 116 may be extremely thin, there may be substantially no interval between the light guide plate body 112 and the reflection plate 120, with only an optical interface therebetween.

The LED assembly 130 includes a wiring substrate 132 such as a metal substrate, three LED chips 134 mounted on the wiring substrate 132 and transparent packages 136 each sealing the respective LED chip 134.

On the surface of the wiring substrate 132, wires (not shown) for supplying electricity to the LED chips 134 are formed by preferably, coating or cladding. At this time, it is desirable that the wires are formed extensively on the surface of the wiring substrate 132 so as to increase the reflection efficiency by which the light from the LED chip 134 is reflected forward.

In addition, the above example presents the single wiring substrate 132 with the three LED chips 134 and packages 136 mounted thereon, but there may be a plurality of wiring substrates with each of the LED chips 134 and the packages 136 mounted thereon, respectively.

It is preferable that each of the LED chips 134 is disposed in the corresponding position in each groove 114 of the light guide plate 110, and each of the transparent packages are formed in a dimension that is fitted into each of the grooves 114. Thereby, when the LED assembly 130 is conjoined with the light guide plate 110, the transparent packages 136 can be fitted into the grooves 114 without any gaps. As a result, when the light from the LED chips 134 enters the light guide plate 110, the loss of light through the gaps can be prevented.

Meanwhile, it is preferable that the package 136 is bonded with the groove 114 with a transparent adhesive. In addition, it is preferable that the package 136 and the adhesive are made of material having substantially the same refraction index as the light guide plate 110.

The reflection layer 140 is disposed, in a form of thin film on the peripheral side of the light guide plate 110 where the grooves 114 are formed. That is, the reflection layer 140 covers the LED packages 136 and the portions of the light guide plate body 112 alternating with the LED packages 136 to prevent the light from the LED chip 134 leaking outside the light guide plate 110.

At this time, the reflection layer 140 is formed to cover the upper and lower surfaces of the LED packages 136 as well as the upper, lower and side surfaces of the adjacent portion of the light guide plate body 112. That is, as shown in FIG. 2, the reflection layer 140 is formed along the upper surface of the LED packages 136 and the upper and side surfaces of the light guide plate body 112. Also, as shown in FIG. 6, the reflection layer 140 is formed on the lower surfaces of the LED packages 136 as well as the lower surface of the portions of the light guide plate body 112 alternating with the LED packages 136 as shown in FIG. 7. In FIG. 6, the upper reflection layer is denoted with the reference numeral 140a and the lower reflection layer is denoted with the reference numeral 140b for convenience.

The upper reflection layer 140a is formed to cover the upper surfaces of the packages 136 as well as the adjacent portion of the light guide plate body 112. This is to prevent the light from the LED chip from leaking through the upper surface of the light guide plate 110 without impinging on the dot patterns 116. In other words, the upper reflection layer 140a has such a width that enables preventing the light from leaking directly through the upper surfaces of the package 136 and/or the light guide plate 110. Referring to FIG. 6, when the light emitted from the LED chip 134 impinges on the package 136 or the light guide plate 110 in an angle of predetermined value or less, it is reflected downward by total internal reflection. However, if the light impinges on the upper surface of the package 136 or the light guide plate 110 in an angle greater than the certain value, it penetrates the upper surface to escape upward. Therefore, it is preferable that the upper reflection layer 140a has a width that can prevent such possibility. If needed, the width of the upper reflection layer 140a can be adjusted to let parts of light escape upward directly through the upper surface of the package 134 and/or the light guide plate 110 without impinging on the dot patterns on the bottom surface of the light guide plate 110. At this time, the package 136 may have a sufficiently large width such that the width of the upper reflection layer 140a may be smaller than the width of the package 136.

On the other hand, it is not problematic for the lower reflection layer 140b to have a smaller width than the upper reflection layer 140a since the light that escapes through the bottom surface of the light guide plate 110 is reflected back into the light guide plate 110 by the reflection plate 120 underneath. Also, the side portions of the reflection layer 140 and the lower reflection layer 140b may also be formed in the same width as the upper reflection layer 140a.

Alternatively, the lower reflection layer 140b can be substituted with a reflection plate (of thin surface), which is especially preferable when the dot patterns 116 and the reflection plate 120 have large thicknesses.

The reflection layer 140 is made into a form of film by using material of high reflectivity. The material usable in this case includes metal and reflective paint.

For the metal, metal of high reflectivity such as 90% or higher, for example, Ag, Al, Au, Cu, Pd, Pt, Rd and alloys thereof, can be used individually or in combination. It is preferable that the reflection layer has a thickness of at least 1,000 Å, more preferably, 3,000 Å to 1 μm. In addition, the reflection layer is formed preferably via deposition.

For the deposition, sputtering and electron beam method can be used.

The sputtering flows sputtering gas into a vacuum chamber to collide it against a target, thereby forming plasma from target material, so that the plasma is coated in the form of a thin film on a substrate. Generally, the sputtering gas utilizes inactive gas such as Ar.

Describing the sputtering process in brief, when a voltage is applied to the target functioning as a cathode and a substrate functioning as an anode, sputtering gas is excited into Ar⁺ ions through collision with electrons emitted from the anode. Then, the Ar⁺ ions are attracted toward and collide against the target functioning as the anode. Since the excited Ar⁺ ions each have a predetermined energy hu, the energy is delivered to the target during collision. When the energy exceeds the bonding force of a target element and the work function of the electrons, plasma is emitted from the target. The plasma rises up to the extent of the free path of electrons, and when the substrate is spaced from the target within the free path, forms a thin film on the substrate.

A type of sputtering using a DC voltage is referred to as DC sputtering, and generally used for the deposition of conductors. In case of nonconductors such as insulators, a thin film is formed via AC sputtering using an AC voltage. The AC sputtering is also referred to as Radio Frequency (RF) sputtering since it uses an AC voltage typically having a frequency of 13.56 MHz.

The electron beam deposition uses electron beams to heat a holder in a high vacuum atmosphere (i.e., 5×10⁻⁵ to 1×10⁻⁷ torr). In this fashion, metal on the holder is melted and evaporated so that metal vapors are condensed on the surface of a wafer that is relatively cold. The electron beam deposition is mainly used for the fabrication of a thin film on a semiconductor wafer.

In the case where the reflection layer is formed by the metal of high reflectivity, there may be electric connection between the reflection layer 140 and the wiring substrate (not shown), and therefore, it is preferable to form the wires such that the wires are not extended to the periphery of the wiring substrate 132. That is, the wires are formed to maintain a predetermined distance from the periphery of the wiring substrate 132 so that the electric connection between the wires and the metal reflection layer 140 can be prevented.

For the reflective coating, reflective material which contains TiO₂, ZnO or CaCo₃ having 80% to 90% of reflectivity can be used individually or in combination.

Such reflective material is diluted with an adhesive in a solvent to be applied to the upper and lower surfaces of the packages 136 and the corresponding portions of the adjacent light guide plate body 112 in order to form the reflection layer 140. At this time, the reflective material can be diluted in 10 to 50 wt % of concentration, preferably 20 to 30 wt % of concentration and is applied using a spray and a roller. The reflective material may be applied in a thickness of 1,000 Å to 10 μm, and preferably 3,000 Å to 1 μm.

As described above, the LED packages 136 are inserted into the grooves 114 of the light guide plate 110, and thus the light from the LED chip 134 can enter the light guide plate 110 without any loss. In addition, being in a form of film, the reflection layer 140 can be formed in a precise, small thickness through a convenient process.

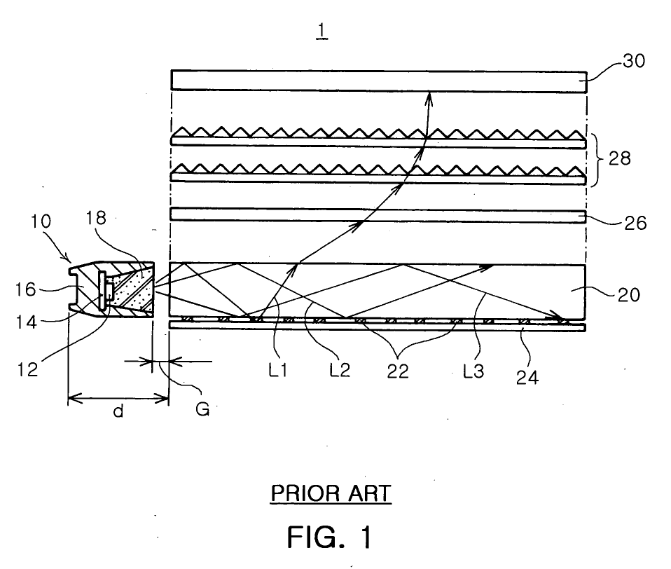

Such reflection layer 140 of the present invention serves substantially the same function as the portion of the package body 16 surrounding the transparent resin of the side type LED 10, i.e., the sidewall of the side type LED 10 as shown in FIG. 1. That is, the prior art side type LED 10 adopted in a typical small backlight apparatus for an LCD has a sidewall that is designed to emit the light from the LED chip 12 into the light guide plate 20 within a predetermined range of a vertical beam angle. At this time, the sidewall is injection-molded with the package body 16, thus requiring a certain thickness or greater. Therefore, the sidewall acts as a hindrance to reducing the thickness of the side type LED 10 and the backlight apparatus 1.

In the present invention, as the reflection layer 140 serves the function of the sidewall of the prior art side type LED 10, the thickness of the transparent package 136 can be considerably reduced. That is, the transparent package 136 needs to have a thickness just sufficient enough to seal the LED chip 12 inside thereof. In addition, as the reflection layer 140 is formed by deposition, the thickness of the reflection layer 140 accounts for a negligible portion in the entire dimension of the light source-guide structure 100. Thus, the thickness of the light source-guide structure 100 is mainly affected by the thickness of the transparent package 136 or the LED chip 12.

Considering the above factors, the light source-guide structure 100 of the present invention enhances light efficiency while considerably reducing the thickness.

The above described light source-guide structure 100 according to the present invention constitutes a backlight apparatus together with a diffusion plate 26 and a prism sheet 28 as shown in FIG. 1. The merits of the above described light source-guide structure 100 also apply to the backlight having the same.

In the mean time, as shown in FIG. 8, the reflection plate and the reflection layer can be modified in their forms. FIG. 8 is a sectional view corresponding to FIG. 6, illustrating a variation of the light source-guide structure according to the first embodiment.

According to the configuration in FIG. 8, the lower reflection layer 140b is formed in the same width as the upper reflection layer 140a. The remaining configuration is substantially identical to the light source-guide structure 100 according to the first embodiment described above, and thus the explanation thereof is omitted.

In addition, the reflection plate and the reflection layer can be modified in their forms, as shown in FIG. 9. FIG. 9 is a sectional view corresponding to FIG. 6, illustrating another variation of the light source-guide structure according to the first embodiment.

According to the configuration in FIG. 9, the reflection plate 120a covers also the lower surface of the transparent package 136. That is, instead of forming the lower reflection layer, the reflection plate 120a can be extended to the lower surface of the transparent package 136. Naturally, the reflection plate 120a also covers the lower surfaces of the light guide plate body 112 alternating with the packages 136.

At this time, the package 136 may have a thickness bit greater than the light guide plate body 112. However, as described above, when the dot patterns 116 are formed very thin with ink dots, there is substantially no increase in the thickness by the dot patterns 116, and therefore, the package 136 does not need to have a thickness greater than the light guide plate body 112.

The features and merits of the reflection layer 140, the reflection plate 120a and the light source-guide structure including the same are substantially identical to those of the first embodiment described above.

Hereinbelow, the operations of the light source-guide structure according to the present invention is explained with reference to aforementioned FIG. 6.

When the LED chip 134 emits light, parts of light L1 is reflected by the upper reflection layer 140a covering the package 136 into the light guide plate 110. This light L1 moves about in the light guide plate 110 and when it meets the dispersion pattern 116, it is reflected upward by the reflection plate 120 to escape through the upper surface of the light guide plate 110. Then it penetrates-through the diffusion plate 26 and the prism sheet 28 above to backlight the LCD panel 30.

In the meantime, other parts of light L2 incident through the package 136 and the light guide plate 110 are reflected by the upper reflection layer 140a toward the bottom surface of the light guide plate 110. The path of the light L2 afterwards is the same as that of the above described light L1.

In addition, yet another parts of light L3 impinge on the dot patterns 116 of the bottom surface of the light guide plate 110 and reflected by the reflection plate 120 to escape through the upper surface of the light guide plate 110, backlighting the LCD panel 30 (FIG. 1).

Rest of the light impinges on the upper or lower surface of the light guide plate 110 to be reflected, in the same fashion as the light L3, moving about in the light guide plate 110. Then when it meets the dot pattern 116, it is reflected upward by the reflection plate 120 to escape through the upper surface of the light guide plate 110.

Therefore, the light from the LED chip 134 enters the light guide plate 110 (except when the light is absorbed at the package) without a loss, increasing light efficiency. In addition, the width of the upper reflection layer 140a can be appropriately adjusted so that the amount of light that escapes above without impinging on the dot pattern can be adjusted.

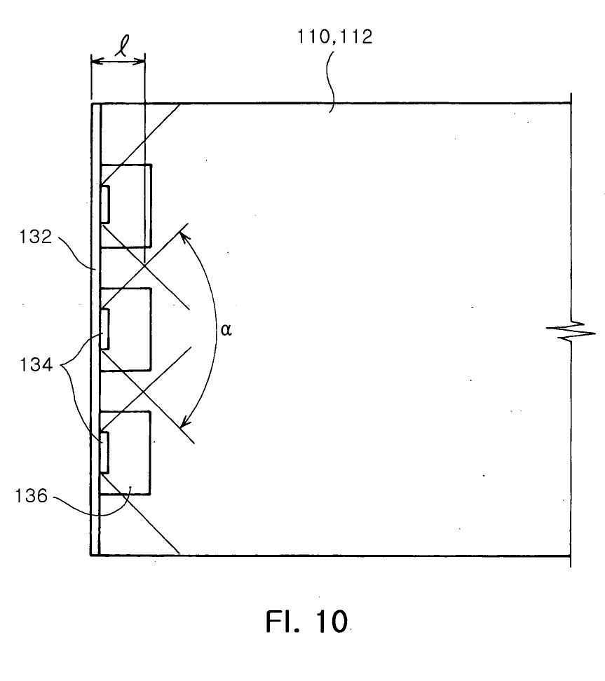

Hereinbelow, the operations of the light source-guide structure according to the present invention is explained with reference to FIG. 10 in a plan view.

As described above, since the LED package 136 according to the present invention is made of transparent resin, the light from the LED chip 134 can enter the light guide plate 110 through the side surface of the package 136 as shown in FIG. 10. Thus, a wider horizontal beam angle a is realized with the light source-guide structure of the present invention.

As a result, the light guide plate 110 is capable of illuminating a larger area with a single LED chip 134, thus requiring a fewer number of LED chips 134.

In addition, with the wider beam angle α, the distance l in which the emitted lights from the adjacent LED chips 134 are mixed with each other becomes shorter. This distance l of mixed light is in proportion to the width of the Bezel area, and therefore the width of the Bezel area can be decreased according to the decrease in the distance l of mixed light.

Thereby, the LCD adopting the light source-guide structure of the present invention and the backlight apparatus including the same of the present invention can be considerably decreased in size. In other words, given the same size of the LCD, the LCD adopting the backlight apparatus of the present invention can have a larger liquid crystal panel than the prior art LCD.

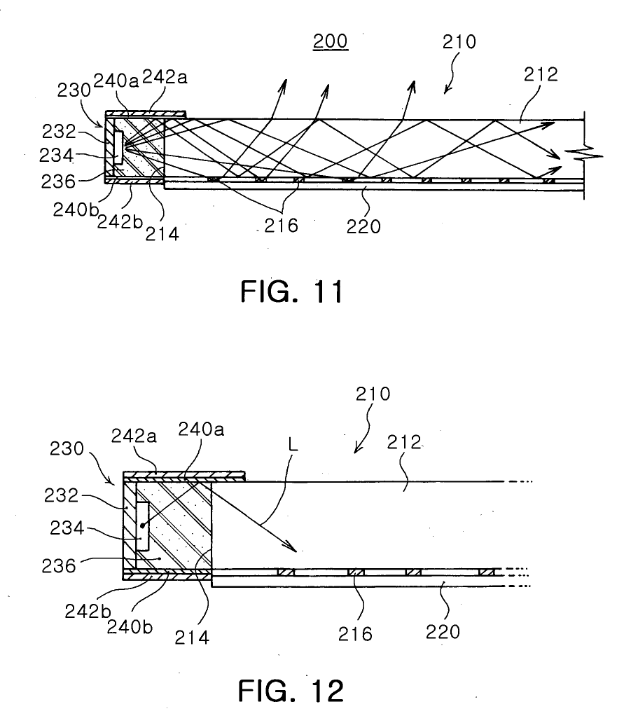

FIG. 11 is a sectional view corresponding to FIG. 6, illustrating the light source-guide structure according to a second embodiment of the present invention.

The light source-guide structure 200 in the embodiment is substantially identical to the light source-guide structure according to the first embodiment, except having a dual reflection layer structure composed of inner layers 240a and 240b and outer layers 242a and 242b. Therefore, the constituents are denoted with reference numerals in the 200s, with the additional explanation omitted.

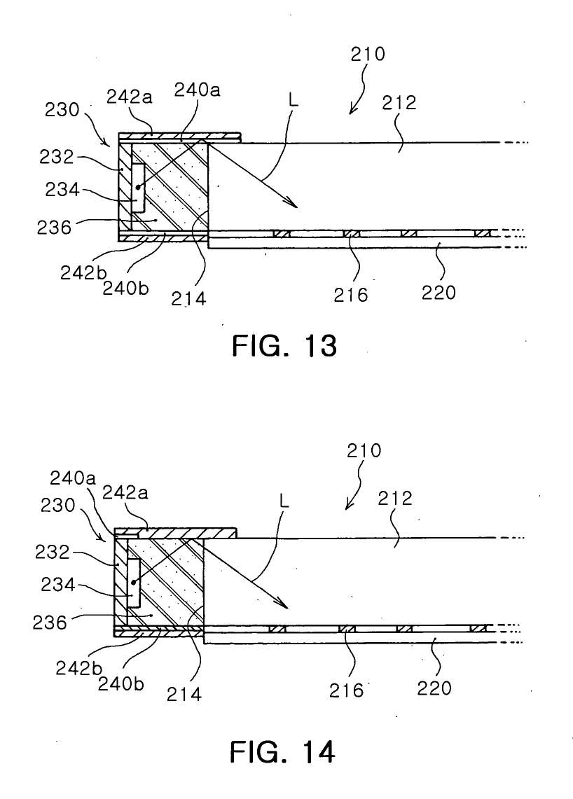

Now, the dual reflection layer structure of FIG. 11 is explained in detail with reference to FIGS. 12 and 13.

With reference to FIG. 12, the inner layers 240a and 240b are formed with reflective coating and the outer layers 242a and 242b are formed with metal. Therefore, the light L emitted from the LED chip 234 is reflected by the inner layers 240a and 240b before reaching the outer layers 242a and 242b.

The preferable example of the reflective coating includes individual or combinational use of TiO₂, ZnO and CaCo₃.

The configuration and formation process of the reflection layer, i.e., the inner layers 240a, 240b are as explained in the first embodiment.

In the meantime, the outer layers 242a and 242b are formed to protect the inner layers 240a and 240b from the external environment and preferably formed by deposition. The outer layers 242a and 242b can use any metal that is appropriate for deposition.

In addition, the outer layers 242a and 242b can be formed with metal of high reflectivity to additionally reflect parts of light that are not reflected but permeated at the inner layers 240a and 240b. For such metal of high reflectivity, Ag, Al, Au, Cu, Pd, Pt, Rd and alloys thereof can be used individually or in combination. At this time, it is preferable that the outer layers 242a and 242b can have a thickness of at least 1,000 Å, and more preferably 3,000 Å to 1 μm.

Referring to FIG. 13, the outer layers 240a and 240b are formed with transparent dielectric material and the outer layers 242a and 242b are formed with metal of high reflectivity in the dual reflection layer structure. Therefore, the light L emitted from the LED chip 234 penetrates the inner layer 240a or 240b and reflected by the outer layer 242a or 242b.

The examples of transparent dielectric material include Al₂O₃, SiN₅ and SiO₂, which can be deposited individually or in combination to form the transparent inner layer 240a, 240b in a form of thin film. The dielectric material is deposited to form an electric insulation layer or a passivation layer in order to preclude electric connection between the wires or conductive patterns (not shown) of the wiring substrate 232 and the outer layers 242a, 242b, which are the metal reflection layer. The inner layers 240a and 240b are also formed by deposition, and thus highly stable.

For the metal for the outer layers 242a and 242b, metals of high reflectivity such as 90% or higher, for example, Ag, Al, Au, Cu, Pd, Pt, Rd and alloys thereof can be used individually or in combination. The outer layers 242a and 242b can have a thickness of at least 1,000 Å, and preferably 3,000 Å to 1 μm. In addition, the outer layers are preferably formed by deposition, which entails substantially the same process as that of the reflection layer 140 of the first embodiment described above.

With the above configuration, the conductive patterns (not shown) which reflect the light from the LED chip 234 forward can be extended to the periphery of the wiring substrate 232, thereby increasing reflection efficiency of the wiring substrate 232.

In the meantime, FIG. 14 shows a variation of the light source-guide structure in FIG. 13.

Instead of forming the inner layers 240a and 240b in the same width as the outer layer 242a and 242b, the passivation or insulation region 240a can be formed only in the periphery of the upper surface of the wiring substrate 232 and the adjacent upper surfaces of the packages 236 as shown in FIG. 11.

The above configuration allows the same effects as the configuration of FIG. 13. In addition, the insulation region 240a is formed in such a narrow portion that opaque material can be used to form the insulation region 240a.

The above described light source-guide structure in FIGS. 12 to 14 constitutes the backlight apparatus according to the present invention together with the diffusion plate 26 and the prism sheet 28.

According to the light source-guide structure and the backlight apparatus including the same of the present invention as set forth above, the light source is inserted into the light guide plate to minimize the loss of light entering the light guide plate from the LED, increasing the amount of light incident while increasing the horizontal beam angle of the light emitted from the LED to minimize the peripheral area. In addition, the reflection layer is applied or deposited on the upper and lower surfaces of the light source as well as the upper surface of the light guide plate alternating with the light source, preventing the light from leaking outside. Moreover, with the reflection layer formed also on the portion of the light guide plate adjacent to the light source, the light from the light source can be prevented from leaking upward to form a bright line on the liquid crystal panel. Furthermore, according to the present invention, the light source package is formed with transparent resin and the reflection layer and optionally the reflection plate of the lower part of the light guide plate serve the function of the sidewall of the light source. Thus, there is no need for a sidewall as in the prior art side type LED, and as a result, the thickness of the light source-guide structure and the backlight apparatus adopting the same can be considerably reduced.

While the present invention has been shown and described in connection with the preferred embodiments, it will be apparent to those skilled in the art that modifications and variations can be made without departing from the spirit and scope of the invention as defined by the appended claims.

1. A light source-guide structure of a backlight apparatus comprising:
a light guide plate having a groove formed in a peripheral side thereof, the groove extended through the thickness of the light guide plate;
a light source including a transparent package fitted into the groove of the light guide plate, a light emitting diode chip disposed inside the transparent package, a wiring substrate for seating the light emitting diode chip and reflecting the light from the light emitting diode chip to the light guide plate; and
a reflection layer attached on an upper surface of the light source and an upper surface of a portion of the light guide plate into which the light emitting diode light source is fitted.

2. The light source-guide structure of a backlight according to claim 1, wherein the package of the light source is bonded to the groove of the light guide plate with an adhesive.

3. The light source-guide structure of a backlight according to claim 1, wherein the reflection layer, attached on the upper surfaces of the transparent package and of the portion of the light guide plate, is formed in such a width that light incident directly from the light emitting diode chip out of total internal reflection condition does not escape through the upper surface of the transparent package or the light guide plate.

4. The light source-guide structure of a backlight according to claim 1, wherein the reflection layer is formed on a lower surface of the light source as well as a lower surface of the portion of the light guide plate into which the light emitting diode light source is fitted.

5. The light source-guide structure of a backlight according to claim 4, wherein the reflection layer formed on the upper surfaces of the light source and the light guide plate has a larger width than the reflection layer formed on the lower surfaces of the light emitting diode light source and the light guide plate.

6. The light source-guide structure of a backlight according to claim 1, wherein the reflection layer is formed on side surfaces of the portion of the light guide plate into which the light emitting diode light source is fitted.

7. The light source-guide structure of a backlight according to claim 1, wherein the reflection layer is made of metal or reflective coating.

8. The light source-guide structure of a backlight according to claim 7, wherein the reflection layer comprises metal deposit.

9. The light source-guide structure of a backlight according to claim 8, wherein the metal deposit comprises at least one selected from a group consisting of Ag, Al, Au, Cu, Pd, Pt, Rd and alloys thereof.

10. The light source-guide structure of a backlight according to claim 8, further comprising a transparent insulation layer formed on a lower part of the reflection layer.

11. The light source-guide structure of a backlight according to claim 10, wherein the transparent insulation layer comprises deposit of at least one selected from a group consisting of Al₂O₃, SiN, and SiO₂.

12. The light source-guide structure of a backlight according to claim 10, wherein the transparent insulation layer is formed on the entire lower part of the reflection layer or in the vicinity of the wiring substrate.

13. The light source-guide structure of a backlight according to claim 7, wherein the reflection layer comprises reflective coating.

14. The light source-guide structure of a backlight according to claim 13, wherein the reflective coating comprises at least one selected from a group consisting of TiO₂, ZnO, CaCo₃ and a mixture thereof.

15. The light source-guide structure of a backlight according to claim 13, further comprising a metal deposit layer formed on an upper surface of the reflection layer.

16. The light source-guide structure of a backlight according to claim 15, wherein the metal deposit layer comprises at least one selected from a group consisting of Ag, Al, Au, Cu, Pd, Pt, Rd and alloys thereof.

17. The light source-guide structure of a backlight according to claim 1, wherein the transparent package is tightly fitted into the groove of the light guide plate, having the same shape as the groove of the light guide plate.

18. The light source-guide structure of a backlight according to claim 1, further comprising dot patterns formed on a bottom surface of the light guide plate and a reflection plate disposed underneath the dot patterns.

19. The light source-guide structure of a backlight according to claim 18, wherein the reflection plate covers the entire lower surfaces of the light emitting diode package and the light guide plate.

20. A backlight apparatus comprising:
the light source-guide structure described in claim 18;
a diffusion plate disposed above the light source-guide structure; and
a prism sheet disposed above the diffusion plate.
